(19) United States
(12) Patent Application Publication
(10) Pub. No.: US 2024/0113845 A1
(43) Pub. Date: Apr. 4, 2024

(54) APPARATUS AND METHOD FOR INDICATING CARRIER AGGREGATION CAPABILITY

(71) Applicant: Apple Inc., Cupertino, CA (US)

(72) Inventors: Fucheng Wang, Cupertino, CA (US); Anatoliy S. Ioffe, Sunnyvale, CA (US)

(21) Appl. No.: 18/086,275

(22) Filed: Dec. 21, 2022

Related U.S. Application Data
(60) Provisional application No. 63/411,454, filed on Sep. 29, 2022.

(51) Int. Cl. H04L 5/00

(52) U.S. Cl. CPC H04L 5/0098

(57) ABSTRACT

User equipment indicates its maximum aggregated bandwidth capability to a base station. The user equipment may also indicate a maximum bandwidth capability for each component carrier. Additionally or alternatively, the base station may assume that the maximum aggregated bandwidth capability is also supported by the user equipment for lower order carrier aggregation bandwidth classes having aggregated bandwidth upper limits greater than or equal to the maximum aggregated bandwidth capability. Further, the user equipment may indicate a maximum number of components carriers capable of supporting a maximum components carrier bandwidth. The user equipment may indicate the maximum aggregated bandwidth capability via a new signaling capability added to a standard (e.g., the Third Generation Partnership Project (3GPP) standard), or via existing signaling provided by the 3GPP standard, such as by using a frequency separation class signal.

### CROSS-REFERENCE TO RELATED APPLICATIONS

This application claims priority to U.S. Provisional Application No. 63/411,454, filed Sep. 29, 2022, entitled “APPARATUS AND METHOD FOR INDICATING CARRIER AGGREGATION CAPABILITY,” the disclosure of which is incorporated by reference herein in its entirety for all purposes.

### BACKGROUND

The present disclosure relates generally to wireless communication, and more specifically to aggregating component carriers for use in wireless communication.

User equipment (e.g., a wireless communication device) may employ carrier aggregation by aggregating multiple component carriers or frequency blocks to increase data throughput (e.g., downlink or uplink). In particular, the user equipment may signal a carrier aggregation bandwidth class that it supports to a base station, so that it may be allocated carriers to transmit and/or receive signals. However, a framework for signaling the carrier aggregation bandwidth class may not fully define the user equipment's capability for carrier aggregation.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, user equipment includes: a transmitter configured to transmit a first indication of a maximum aggregated bandwidth capability to a base station; a receiver configured to receive a second indication of aggregated component carriers based on the maximum aggregated bandwidth capability from the base station; and processing circuitry configured to transmit, via the transmitter, or receive, via the receiver, signals using the aggregated component carriers.

In another embodiment, one or more non-transitory, tangible, computer-readable media storing instructions that, when executed, cause one or more processors to: receive a first indication of a maximum aggregated bandwidth capability from user equipment; allocate aggregated component carriers based on the maximum aggregated bandwidth capability to the user equipment; and transmit a second indication of the aggregated component carriers to the user equipment.

In yet another embodiment, a method includes: transmitting, via a transmitter of user equipment, a first indication of a maximum aggregated bandwidth capability to a base station; receiving, via a receiver of the user equipment, a second indication of aggregated component carriers based on the maximum aggregated bandwidth capability from the base station; and transmitting, via the transmitter, or receiving, via the receiver, signals using the aggregated component carriers.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of user equipment, according to embodiments of the present disclosure;

FIG. 2 is a functional diagram of the user equipment of FIG. 1, according to embodiments of the present disclosure;

FIG. 3 is a schematic diagram of a communication system including the user equipment of FIG. 1 communicatively coupled to a wireless communication network supported by base stations, according to embodiments of the present disclosure;

FIG. 4 is a table of New Radio (NR) Frequency Range 1 (FR1) carrier aggregation bandwidth classes, as defined by the Third Generation Partnership Project (3GPP);

FIGS. 5A and 5B are a table of NR Frequency Range 2 (FR2) carrier aggregation bandwidth classes, as defined by the 3GPP;

FIG. 6 is a flowchart of a method for performing carrier aggregation by indicating a maximum aggregated bandwidth capability and a maximum bandwidth capability for each component carrier, according to embodiments of the present disclosure;

FIG. 7 is a flowchart of a method for performing carrier aggregation by indicating a maximum aggregated bandwidth capability and assuming that the maximum aggregated bandwidth capability is also supported by the user equipment of FIG. 1 for lower order carrier aggregation bandwidth classes having aggregated bandwidth upper limits greater than or equal to the maximum aggregated bandwidth capability, according to embodiments of the present disclosure;

FIG. 8 is a flowchart of a method for performing carrier aggregation by indicating a maximum aggregated bandwidth capability and a maximum number of components carriers capable of supporting a maximum components carrier bandwidth, according to embodiments of the present disclosure; and

FIG. 9 is a table of frequency separation classes for noncontiguous intra-band operation.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to signaling a carrier aggregation capability by user equipment (UE) to a base station. In particular, the user equipment may signal a carrier aggregation bandwidth class that it supports to a base station, so that it may be allocated carriers to transmit and/or receive signals. However, a framework for signaling the carrier aggregation bandwidth class may have excessive signaling overhead and/or may not fully define the user equipment's capability for carrier aggregation. In particular, under a current framework, a user equipment may not indicate its maximum aggregated bandwidth capability, and instead indicate a carrier bandwidth configuration under a carrier aggregation bandwidth class and/or a component carrier configuration (e.g., FeatureSet signaling as defined by the Third Generation Partnership Project (3GPP)) that may not exceed the maximum aggregated bandwidth capability. However, the component carrier configuration may increase signaling overhead. Additionally, because the component carrier configuration may not exceed the maximum aggregated bandwidth capability, a capability of the user equipment for each component carrier in the component carrier configuration may not be accurately reflected, as it may be limited by ensuring that the component carrier configuration does not exceed the maximum aggregated bandwidth capability.

Embodiments herein provide various apparatuses and techniques to enable the user equipment to indicate its maximum aggregated bandwidth capability to the base station (e.g., as a maximum aggregated bandwidth capability value or field). In one embodiment, the user equipment may also indicate a maximum bandwidth capability for each component carrier, for example, using the FeatureSet signaling as defined by the 3GPP (as opposed to indicating a component carrier configuration that is limited by the maximum aggregated bandwidth capability).

In another embodiment, the user equipment may indicate its maximum aggregated bandwidth capability to the base station. The base station may then assume that the maximum aggregated bandwidth capability is also supported by the user equipment for lower order carrier aggregation bandwidth classes having aggregated bandwidth upper limits greater than or equal to the maximum aggregated bandwidth capability. In some cases, the user equipment may indicate to the base station that it should not follow this assumption (e.g., by providing a component carrier configuration, such as by providing the FeatureSet signaling as defined by the 3GPP). In such cases, the user equipment may use the component carrier configuration to indicate its maximum aggregated bandwidth capability to the base station.

In yet another embodiment, the user equipment may indicate its maximum aggregated bandwidth capability to the base station. The user equipment may also indicate a maximum number of components carriers capable of supporting a maximum components carrier bandwidth. For example, the user equipment may indicate a carrier aggregation bandwidth class that corresponds to the maximum number of components carriers capable of supporting the maximum components carrier bandwidth.

Moreover, in any of the disclosed embodiments described above, the user equipment may indicate the maximum aggregated bandwidth capability using existing signaling provided by the 3GPP standard, such as by indicating the maximum aggregated bandwidth capability using a frequency separation class signal.

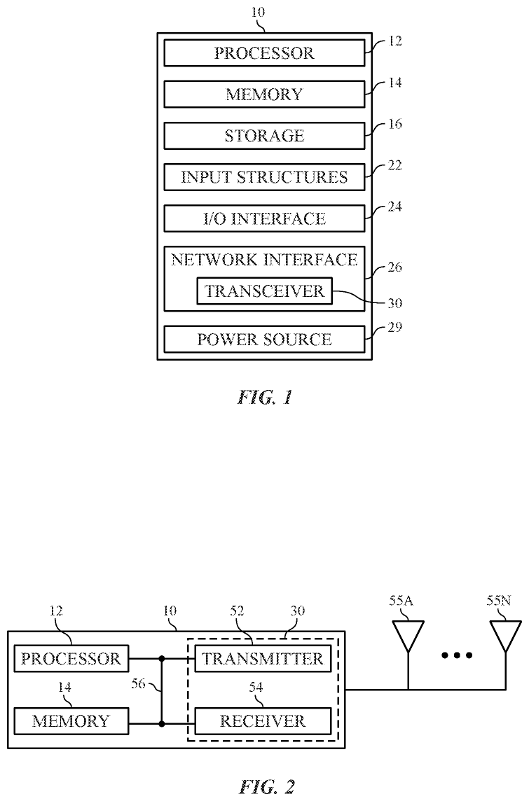

FIG. 1 is a block diagram of user equipment 10, according to embodiments of the present disclosure. The user equipment 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the user equipment 10.

By way of example, the user equipment 10 may include any suitable computing device, including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the user equipment 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the user equipment 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the user equipment 10 to provide various functionalities.

In certain embodiments, the display 18 may facilitate users to view images generated on the user equipment 10. In some embodiments, the display 18 may include a touch screen, which may facilitate user interaction with a user interface of the user equipment 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the user equipment 10 may enable a user to interact with the user equipment 10 (e.g., pressing a button to increase or decrease a volume level). The I/O interface 24 may enable user equipment 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, Long Term Evolution (LTE®) cellular network, Long Term Evolution License Assisted Access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the user equipment 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the user equipment 10 may include any suitable source of power, such as a rechargeable lithium polymer (Li-poly) battery and/or an alternating current (AC) power converter.

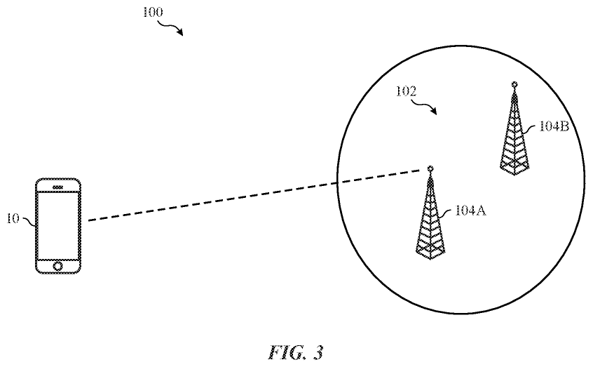

FIG. 2 is a functional diagram of the user equipment 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive signals between one another.

The user equipment 10 may include the transmitter 52 and/or the receiver 54 that respectively enable transmission and reception of signals between the user equipment 10 and an external device via, for example, a network (e.g., including base stations or access points) or a direct connection. As illustrated, the transmitter 52 and the receiver 54 may be combined into the transceiver 30. The user equipment 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The user equipment 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the user equipment 10 may be coupled together by a bus system 56. The bus system 56 may include a data bus, for example, as well as a power bus, a control signal bus, and a status signal bus, in addition to the data bus. The components of the user equipment 10 may be coupled together or accept or provide inputs to each other using some other mechanism.

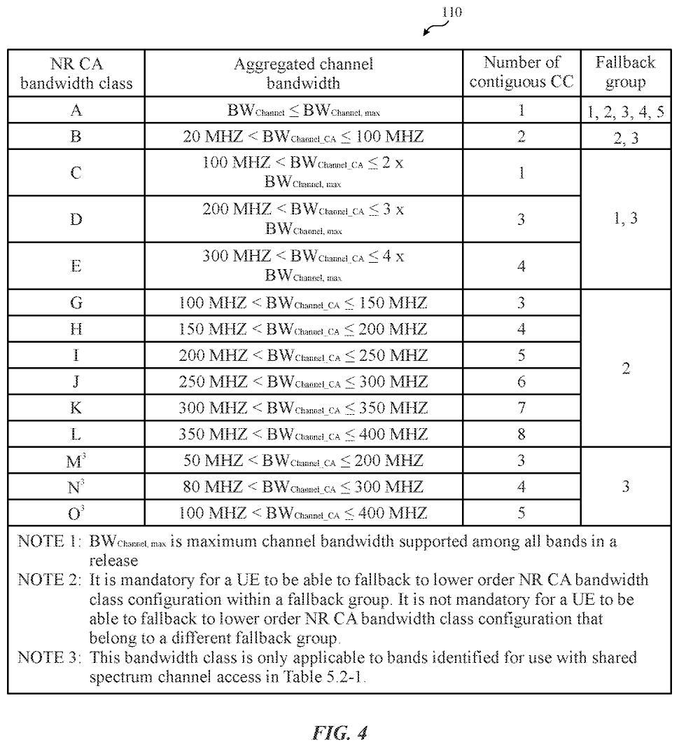

FIG. 3 is a schematic diagram of a communication system 100 including the user equipment 10 of FIG. 1 communicatively coupled to a wireless communication network 102 supported by base stations 104A, 104B (collectively 104), according to embodiments of the present disclosure. In particular, the base stations 104 may include Next Generation NodeB (gNodeB or gNB) base stations and may provide 5G/NR coverage via the wireless communication network 102 to the user equipment 10. The base stations 104 may include any suitable electronic device, such as a communication hub or node, that facilitates, supports, and/or implements the network 102. In some embodiments, the base stations 104 may include Evolved NodeB (eNodeB) base stations and may provide 4G/LTE coverage via the wireless communication network 102 to the user equipment 10. Each of the base stations 104 may include at least some of the components of the user equipment 10 shown in FIGS. 1 and 2, including one or more processors 12, the memory 14, the storage 16, the transceiver 30, the transmitter 52, the receiver 54, and so on. It should be understood that while the present disclosure may use 5G/NR as an example specification or standard, the embodiments disclosed herein may apply to other suitable specifications or standards (e.g., such as the 4G/LTE specification). Moreover, the network 102 may include any suitable number of base stations 104 (e.g., one or more base stations 104, four or more base stations 104, ten or more base stations 104, and so on).

The user equipment 10 may employ carrier aggregation (CA) by aggregating multiple component carriers or frequency blocks to increase data throughput (e.g., downlink or uplink). Carrier aggregation was first introduced in LTE Release 10 specifications and has been successfully deployed in commercial networks since then. Carrier aggregation has also been adopted by the 5G NR standard. Carrier aggregation is intended to increase user equipment capacity beyond what may be delivered by the highest single carrier bandwidth at 20 megahertz (MHz) defined in LTE, 100 MHz in NR Frequency Range 1 (FR1), 400 MHz in NR Frequency Range 2 (FR2), and so on. Three types of carrier aggregation have been defined since LTE: intra-band contiguous carrier aggregation (e.g., aggregating multiple contiguous components carriers within a single frequency band); intra-band non-contiguous carrier aggregation (e.g., aggregating multiple non-contiguous components carriers within a single frequency band); and inter-band carrier aggregation (e.g., aggregating multiple components carriers within multiple frequency bands).

Carrier aggregation is applicable for both downlink and uplink carriers, but some carrier combinations are defined (e.g., by a standards body, such as the 3GPP) only for downlink. For intra-band contiguous carrier aggregation, the 3GPP has defined carrier aggregation bandwidth (BW) classes to indicate a user equipment's capability to support carrier aggregation with respect to a number of aggregated carriers and aggregated channel bandwidth range.

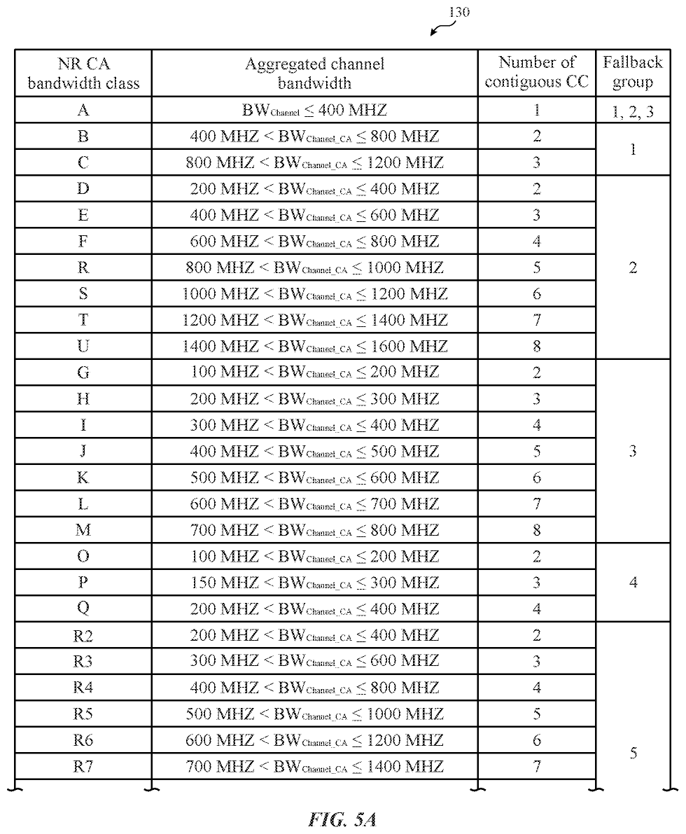

A carrier aggregation fallback rule enables the user equipment 10 to indicate the highest carrier aggregation bandwidth class it supports. The base station 104 may then assume that all lower order carrier aggregation bandwidth classes in the same fallback group are also supported by the user equipment 10, without the user equipment 10 having to provide additional signaling to indicate as such. FIG. 4 is a table 110 of NR FR1 carrier aggregation bandwidth classes, as defined by the 3GPP. Using NR FR1 carrier aggregation bandwidth classes shown in the table 110 as an example, if the user equipment 10 signals NR CA BW class E, then NR CA BW class D and C are both supported by the user equipment 10, without the user equipment 10 transmitting additional signaling to indicate as such. In some embodiments, the maximum channel bandwidth (BW_{channel_max}) may include 100 MHz.

However, though the order carrier aggregation bandwidth classes have been an efficient signaling approach to indicate the user equipment's 10 capability on the supported number of carriers (e.g., “Number of contiguous CC” of the table 110 of FIG. 4) and the maximum aggregated bandwidth (e.g., “aggregated channel bandwidth” of the table 110 of FIG. 4), a granularity of the maximum aggregated BW corresponding to a NR CA BW class definition may not be fine enough to reflect the user equipment's 10 true capability. For example, in FR1, if the user equipment 10 is capable of supporting four component carriers, but with a maximum aggregated bandwidth of 360 MHz (which may be limited by either a radio frequency integrated circuit of the user equipment 10, a baseband processor of the user equipment 10, or both), the user equipment 10 may signal carrier aggregation bandwidth class D to the base station 104. That is, for the user equipment 10 to signal a carrier aggregation bandwidth class, the user equipment 10 may support the full aggregated channel bandwidth of the carrier aggregation bandwidth class. The user equipment 10 may not signal carrier aggregation bandwidth class E, as the maximum aggregated channel bandwidth of carrier aggregation bandwidth class E is 4 times the maximum channel bandwidth (BW_{Channel_max}), which may be 4 times 100 MHz, which is 400 MHz. Because the user equipment 10 may only support a maximum aggregated bandwidth of 360 MHz, it may not indicate that it supports carrier aggregation bandwidth class E, and instead it indicates carrier aggregation bandwidth class D, with a maximum aggregated channel bandwidth of 3 times the maximum channel bandwidth (BW_{Channel_max}), which may be 3 times 100 MHz, which is 300 MHz. In that case, the true user equipment 10 capability may be compromised, as the true user equipment 10 may support four component carriers and a maximum aggregated bandwidth of 360 MHz, but indicates carrier aggregation bandwidth class D that has three component carriers and a maximum aggregated bandwidth of 300 MHz.

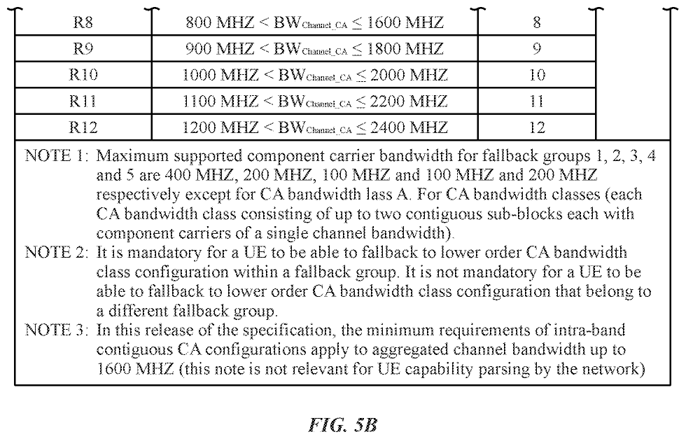

To mitigate this issue, the 3GPP has introduced component carrier configuration (e.g., FeatureSet (FS)) signaling for band combinations to enhance the granularity of the user equipment 10's capability in a band combination, in addition to its single carrier capability. For the same example above, in order to signal the user equipment 10's capability with four component carriers and a maximum aggregated bandwidth of 360 MHz, the user equipment 10 may signal both carrier aggregation bandwidth class E (that supports four component carriers) and a component carrier configuration of {CC1, CC2, CC3, CC4}={100, 100, 100, 60 [in MHz]}. However, the component carrier configuration increases signaling overhead, which may be further increased for the newly introduced Frequency Range 2 (FR2) carrier aggregation bandwidth classes in Fallback Group 5 (FBG2) (see FIGS. 5A and 5B), which is based on a mixture of 100 MHz and 200 MHz carriers that constitute carrier aggregation. Additionally, the network 102 may still not realize the user equipment 10's true bandwidth capability. That is, while, the user equipment 10 may support a maximum of 100 MHz on the fourth carrier (CC4), it indicates 60 MHz, as the aggregated bandwidth of the component carriers indicated in the component carrier configuration should not exceed the maximum aggregated bandwidth of 360 MHz, per the 3GPP standard.

FIGS. 5A and 5B are a table 130 of NR FR2 carrier aggregation bandwidth classes, as defined by the 3GPP. To support aggregated channel bandwidths up to 1600 MHz in FR2, in the 3GPP Radio Access Network 4 (RAN4) #99e meeting, it was first agreed to introduce four new carrier aggregation bandwidth classes R, S, T, and U in Fallback Group 2 (FBG2). Additionally, in the 3GPP RAN4 #103-e meeting, it was agreed to introduce 11 new carrier aggregation bandwidth classes R2-R11 in FBG5 to accommodate for backwards compatibility with existing FR2 component carriers at 100 MHz in Fallback Group 3 (FBG3).

For the newly introduced FR2 carrier aggregation bandwidth classes in FBG5, the aggregated bandwidth may be combined with a mixture of 100 MHz and 200 MHz component carriers. The signaling of the user equipment's 10 maximum aggregated bandwidth capability, which may be less than a carrier aggregation bandwidth class upper limit, to the network 102 may become complicated as the user equipment 10 is assumed to have no prior knowledge on how the carrier aggregation would be configured by the network 102, and the user equipment 10 may have to signal multiple component carrier configurations (e.g., FeatureSets) to cover all possible network configurations. For example, if the user equipment 10 may support 12 component carriers, and each component carrier's maximum bandwidth is 200 MHz, whereas the user equipment's 10 maximum aggregated bandwidth is 1200 MHz, the user equipment 10 may not be able to report its true capability to the network 102 based on the current signaling framework.

That is, the user equipment 10 may signal its maximum aggregated bandwidth as class R6 in the table 130 of FIGS. 5A and 5B as its bandwidth upper range (e.g., 6×200 MHz) aligns with the user equipment's 10 maximum aggregated bandwidth capability. However, the network 102 may be capable of configuring 1200 MHz using any of the following combinations:
2×100 MHz+5×200 MHz (seven component carriers);
4×100 MHz+4×200 MHz (eight component carriers);
6×100 MHz+3×200 MHz (nine component carriers);
8×100 MHz+2×200 MHz (ten component carriers);
10×100 MHz+1×200 MHz (eleven component carriers);
12×100 MHz (twelve component carriers).

As such, 1200 MHz may not be configured to the user equipment 10 that only signals R6, despite the user equipment 10 having the capability to support the configurations listed above. To cover all possible 1200 MHz network configurations, the user equipment 10 may signal all the above component carrier configurations (e.g., FeatureSets) in addition to carrier aggregation bandwidth class R12, which would seemingly defeat the merit of the carrier aggregation bandwidth classes and the fallback rule.

On the other hand, considering that the intended FR2 band supporting FBG5 may be aggregated with FR1 bands where its maximum aggregated bandwidth may also vary depending on FR1 bands' aggregated bandwidth, the signaling complexity and overhead could be rather overwhelming. The issue with the existing signaling framework using the component carrier configurations is that the user equipment's 10 maximum aggregated bandwidth capability is represented by a particular carrier bandwidth configuration under a carrier aggregation bandwidth class. The user equipment's 10 true capability on each supported component carrier (e.g., the maximum bandwidth supported by the user equipment 10 for each component carrier, separate and independent from, and not limited by, the maximum aggregated bandwidth capability of the user equipment 10) may not be fully indicated by a single component carrier configuration (e.g., FeatureSet). For instance, in the above example, if the user equipment 10 signals R12, and the component carrier configuration of 12×100 MHz, the network 102 may misinterpret that the user equipment 10 may only support a maximum 100 MHz in each of the 12 component carriers, despite the user equipment's 10 true capability for each component carrier being 200 MHz.

The disclosed embodiments enable more efficient signaling to indicate user equipment's 10 capability for supporting intra-band contiguous carrier aggregation without resorting to the rather complicated component carrier configuration (e.g., FeatureSet) signaling to reduce or minimize signaling overhead. In one embodiment, the user equipment 10 may indicate its maximum aggregated bandwidth capability to the base station 104 via a new information element (IE), maxaggregatedBW. As noted above, the maximum aggregated bandwidth capability may be independent from the user equipment's 10 per component carrier bandwidth capability. That is, it may not be enforced that the aggregated component carrier bandwidth capability equals the maximum aggregated bandwidth capability, as the aggregated component carrier bandwidth capability may exceed the maximum aggregated bandwidth capability. Additionally, the component carrier configuration (e.g., FeatureSet), per the highest order supported carrier aggregation bandwidth class, may indicate each component carrier's true maximum bandwidth capability (as opposed to being limited by the maximum aggregated bandwidth capability).

Using the same example above, the user equipment 10 may signal the following parameters to the network 102: carrier aggregation bandwidth class R12, maximum aggregated bandwidth capability=1200 MHz, and component carrier configuration {CC1, CC2, CC3, CC4, CC5, CC6, CC7, CC8, CC9, CC10, CC11, CC12}={200, 200, 200, 200, 200, 200, 200, 200, 200, 200, 200, 200}. Indeed, it should be understood that in any of the disclosed embodiments, the user equipment 10 may indicate its carrier aggregation bandwidth class to the base station 104. The network 102 may receive these signals or indications, and determine that the user equipment 10 may support any combinations of 100 MHz and 200 MHz component carriers for carrier aggregation, provided that the total aggregated bandwidth is equal to or less than 1200 MHz. Accordingly, in this embodiment, the component carrier configuration has been altered to indicate an envelope capability (e.g., maximum bandwidth) of the combination of component carriers, and not the per component carrier capability when not used in the combination.

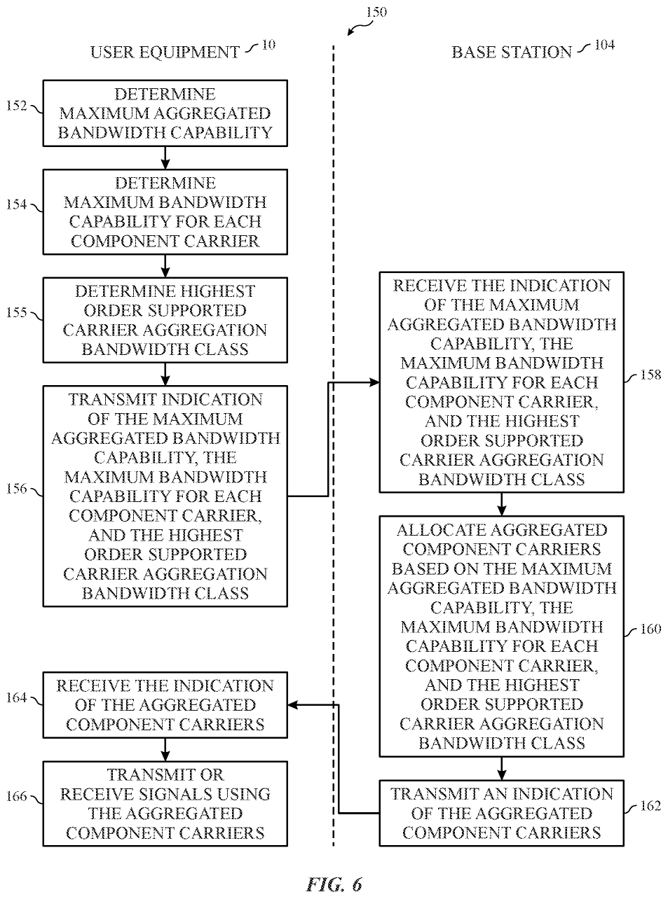

FIG. 6 is a flowchart of a method 150 for performing carrier aggregation by indicating a maximum aggregated bandwidth capability and a maximum bandwidth capability for each component carrier, according to embodiments of the present disclosure. Any suitable device (e.g., a controller) that may control components of the user equipment 10, the base station 104, and/or the network 102, such as the processor 12, may perform the method 150. In some embodiments, the method 150 may be implemented by executing instructions stored in a tangible, non-transitory, computer-readable medium, such as the memory 14 or storage 16, using the processor 12. For example, the method 150 may be performed at least in part by one or more software components, such as an operating system of the user equipment 10, the base station 104, and/or the network 102, one or more software applications of the user equipment 10, the base station 104, and/or the network 102, and the like. While the method 150 is described using steps in a specific sequence, it should be understood that the present disclosure contemplates that the described steps may be performed in different sequences than the sequence illustrated, and certain described steps may be skipped or not performed altogether.

In process block 152, the user equipment 10 determines a maximum aggregated bandwidth capability. In process block 154, the user equipment 10 determines a maximum bandwidth capability for each component carrier. In particular, the maximum bandwidth capability for each component carrier may indicate each component carrier's true maximum bandwidth capability (as opposed to being limited by the maximum aggregated bandwidth capability). In process block 155, the user equipment 10 determines a highest order supported carrier aggregation bandwidth class. In particular, the user equipment 10 may determine a maximum number of component carriers it supports, and determine the highest order supported carrier aggregation bandwidth class based on the maximum number of component carriers. For example, the user equipment 10 may determine the highest order supported carrier aggregation bandwidth class on the table 130 of FIGS. 5A and 5B that corresponds to the maximum number of supported component carriers.

In process block 156, the user equipment 10 transmits an indication of the maximum aggregated bandwidth capability, the maximum bandwidth capability for each component carrier to the base station 104, and the maximum number of supported component carriers. In particular, the maximum aggregated bandwidth capability may be indicated as a single value or in a single field, and be independent from the user equipment's 10 per component carrier bandwidth capability.

In process block 158, the base station 104 receives the indication of the maximum aggregated bandwidth capability, the maximum bandwidth capability for each component carrier to the base station 104, and the maximum number of supported component carriers. In process block 160, the base station 104 and/or the network 102 allocates aggregated component carriers based on the maximum aggregated bandwidth capability, the maximum bandwidth capability for each component carrier to the base station 104, and the maximum number of supported component carriers. In process block 162, the base station 104 transmits an indication of the aggregated component carriers to the user equipment 10.

In process block 164, the user equipment 10 receives the indication of the aggregated component carriers. In process block 166, the user equipment 10 transmits and/or receives signals (e.g., uplinks or downlinks user data) using the aggregated component carriers. In this manner, the method 150 performs carrier aggregation by indicating a maximum aggregated bandwidth capability and a maximum bandwidth capability for each component carrier.

In another embodiment, the user equipment 10 may indicate its maximum aggregated bandwidth capability to the base station 104 via the new information element (IE), maxaggregatedBW. The base station 104 and/or the network 102 may then assume that the maximum aggregated bandwidth capability is also supported by the user equipment 10 for lower order carrier aggregation bandwidth classes having aggregated bandwidth upper limits greater than or equal to the maximum aggregated bandwidth capability. For example, if the user equipment 10 signals R12 a maximum aggregated bandwidth capability of 1600 MHz, then the network 102 may determine that the user equipment 10 may support the following configurations as the highest envelope (e.g., maximum bandwidth) in each carrier aggregation bandwidth class:
R12: 8×100 MHz+4×200 MHz, where the network 102 allocates the aggregated component carriers having an aggregated bandwidth equal to the maximum aggregated bandwidth capability;
R11: 6×100 MHz+5×200 MHz, where the network 102 allocates the aggregated component carriers having an aggregated bandwidth equal to the maximum aggregated bandwidth capability;
R10: 4×100 MHz+6×200 MHz, where the network 102 allocates the aggregated component carriers having an aggregated bandwidth equal to the maximum aggregated bandwidth capability;
R9: 2×100 MHz+7×200 MHz, where the network 102 allocates the aggregated component carriers having an aggregated bandwidth equal to the maximum aggregated bandwidth capability;
R8: 8×200 MHz, where the network 102 allocates the aggregated component carriers having an aggregated bandwidth equal to the maximum aggregated bandwidth capability and/or the maximum bandwidth for the carrier bandwidth class R8;
R7: 7×200 MHz, where the network 102 allocates the aggregated component carriers having an aggregated bandwidth equal to the maximum bandwidth for the carrier bandwidth class R7;
R6: 6×200 MHz, where the network 102 allocates the aggregated component carriers having an aggregated bandwidth equal to the maximum bandwidth for the carrier bandwidth class R6;
R5: 5×200 MHz, where the network 102 allocates the aggregated component carriers having an aggregated bandwidth equal to the maximum bandwidth for the carrier bandwidth class R5;
R4: 4×200 MHz, where the network 102 allocates the aggregated component carriers having an aggregated bandwidth equal to the maximum bandwidth for the carrier bandwidth class R4;
R3: 3×200 MHz, where the network 102 allocates the aggregated component carriers having an aggregated bandwidth equal to the maximum bandwidth for the carrier bandwidth class R3;
R2: 2×200 MHz, where the network 102 allocates the aggregated component carriers having an aggregated bandwidth equal to the maximum bandwidth for the carrier bandwidth class R2.

In some cases, the user equipment 10 may indicate to the base station 104 that it should not follow this assumption (e.g., by providing a component carrier configuration, such as by providing the FeatureSet signaling as defined by the 3GPP). In such cases, the user equipment 10 may use the component carrier configuration to indicate its maximum aggregated bandwidth capability to the base station 104.

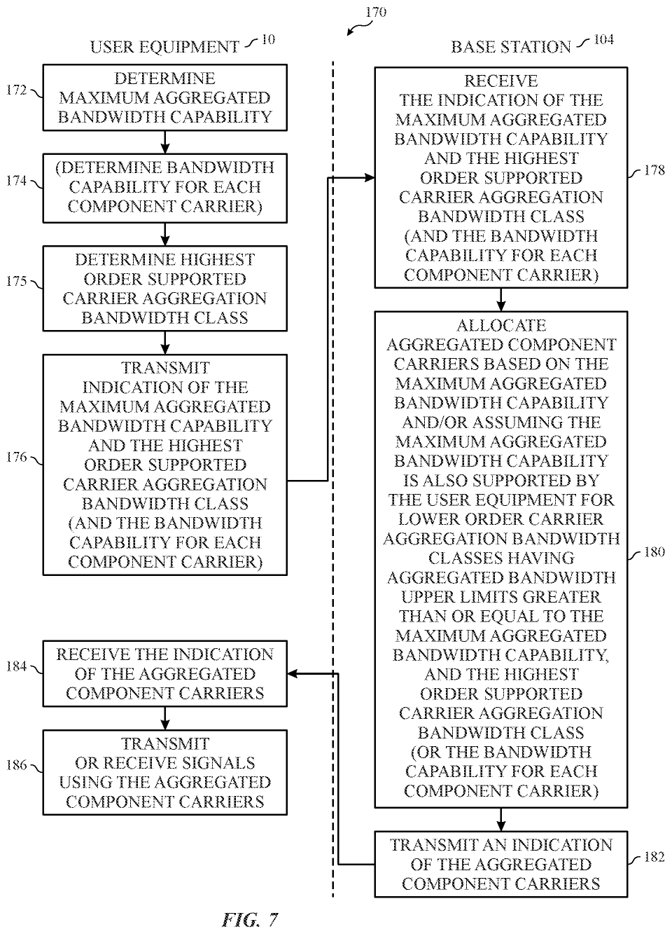

FIG. 7 is a flowchart of a method 170 for performing carrier aggregation by indicating a maximum aggregated bandwidth capability and assuming that the maximum aggregated bandwidth capability is also supported by the user equipment 10 for lower order carrier aggregation bandwidth classes having aggregated bandwidth upper limits greater than or equal to the maximum aggregated bandwidth capability, according to embodiments of the present disclosure. Any suitable device (e.g., a controller) that may control components of the user equipment 10, the base station 104, and/or the network 102, such as the processor 12, may perform the method 170. In some embodiments, the method 170 may be implemented by executing instructions stored in a tangible, non-transitory, computer-readable medium, such as the memory 14 or storage 16, using the processor 12. For example, the method 170 may be performed at least in part by one or more software components, such as an operating system of the user equipment 10, the base station 104, and/or the network 102, one or more software applications of the user equipment 10, the base station 104, and/or the network 102, and the like. While the method 170 is described using steps in a specific sequence, it should be understood that the present disclosure contemplates that the described steps may be performed in different sequences than the sequence illustrated, and certain described steps may be skipped or not performed altogether.

In process block 172, the user equipment 10 determines a maximum aggregated bandwidth capability. In process block 174, the user equipment 10 optionally determines a bandwidth capability for each component carrier. The bandwidth capability for each component carrier may indicate each component carrier's maximum bandwidth capability, such that aggregating the component carriers' maximum bandwidth capabilities does not exceed the maximum aggregated bandwidth capability. In additional or alternative embodiments, the bandwidth capability for each component carrier may indicate each component carrier's true maximum bandwidth capability (as opposed to being limited by the maximum aggregated bandwidth capability). In particular, the user equipment 10 may determine the bandwidth capability for each component carrier if it does not support the maximum aggregated bandwidth capability for lower order carrier aggregation bandwidth classes having aggregated bandwidth upper limits greater than or equal to the maximum aggregated bandwidth capability, and thus does not want the network 102 to operate under this assumption. Otherwise, if the user equipment supports the maximum aggregated bandwidth capability for lower order carrier aggregation bandwidth classes having aggregated bandwidth upper limits greater than or equal to the maximum aggregated bandwidth capability, and thus wants the network 102 to operate under this assumption, it may skip process block 174.

In process block 175, the user equipment 10 determines a highest order supported carrier aggregation bandwidth class. In particular, the user equipment 10 may determine a maximum number of component carriers it supports, and determine the highest order supported carrier aggregation bandwidth class based on the maximum number of component carriers. For example, the user equipment 10 may determine the highest order supported carrier aggregation bandwidth class on the table 130 of FIGS. 5A and 5B that corresponds to the maximum number of supported component carriers.

In process block 176, the user equipment 10 transmits an indication of the maximum aggregated bandwidth capability, the highest order supported carrier aggregation bandwidth class, and, optionally, the bandwidth capability for each component carrier to the base station 104. The maximum aggregated bandwidth capability may be indicated as a single value or in a single field, and be independent from the user equipment's 10 per component carrier bandwidth capability. If the user equipment 10 does not support the maximum aggregated bandwidth capability for lower order carrier aggregation bandwidth classes having aggregated bandwidth upper limits greater than or equal to the maximum aggregated bandwidth capability, then the user equipment 10 may transmit an indication of the bandwidth capability for each component carrier to the base station 104. Otherwise, if the user equipment 10 supports the maximum aggregated bandwidth capability for lower order carrier aggregation bandwidth classes having aggregated bandwidth upper limits greater than or equal to the maximum aggregated bandwidth capability, then the user equipment 10 may not transmit the indication of the bandwidth capability for each component carrier to the base station 104.

In process block 178, the base station 104 receives the indication of the maximum aggregated bandwidth capability, the highest order supported carrier aggregation bandwidth class, and, optionally, the bandwidth capability for each component carrier to the base station 104. In process block 180, the base station 104 allocates aggregated component carriers based on the maximum aggregated bandwidth capability and/or assuming the maximum aggregated bandwidth capability is also supported by the user equipment 10 for lower order carrier aggregation bandwidth classes having aggregated bandwidth upper limits greater than or equal to the maximum aggregated bandwidth capability, and the highest order supported carrier aggregation bandwidth class, or, optionally, the bandwidth capability for each component carrier. That is, if the indication of the bandwidth capability for each component carrier is not received, then the base station 104 allocates aggregated component carriers based on the maximum aggregated bandwidth capability and/or assuming the maximum aggregated bandwidth capability is also supported by the user equipment 10 for lower order carrier aggregation bandwidth classes having aggregated bandwidth upper limits greater than or equal to the maximum aggregated bandwidth capability, as described in the example above. However, if the indication of the bandwidth capability for each component carrier is received, then the base station 104 allocates aggregated component carriers based on the bandwidth capability for each component carrier.

In process block 182, the base station 104 transmits an indication of the aggregated component carriers to the user equipment 10. In process block 184, the user equipment 10 receives the indication of the aggregated component carriers. In process block 186, the user equipment 10 transmits and/or receives signals (e.g., uplinks or downlinks user data) using the aggregated component carriers. In this manner, the method 170 performs carrier aggregation by indicating a maximum aggregated bandwidth capability and assuming that the maximum aggregated bandwidth capability is also supported by the user equipment 10 for lower order carrier aggregation bandwidth classes having aggregated bandwidth upper limits greater than or equal to the maximum aggregated bandwidth capability.

In yet another embodiment, the user equipment 10 may indicate its maximum aggregated bandwidth capability to the base station 104 via the new information element (IE), maxaggregatedBW. The user equipment 10 may also indicate a maximum number of components carriers capable of supporting a maximum components carrier bandwidth. For example, the user equipment 10 may indicate a carrier aggregation bandwidth class that corresponds to the maximum number of components carriers capable of supporting the maximum components carrier bandwidth. In such an embodiment, the network 102 may not assume that the maximum aggregated bandwidth capability is supported by the user equipment 10 for lower order carrier aggregation bandwidth classes (e.g., where an aggregated bandwidth upper limit of a lower order carrier aggregation bandwidth class is higher than or equal to the lower order carrier aggregation bandwidth classes), as opposed to the previously described embodiment. For example, the user equipment 10 may rely on additional signaling for the carrier aggregation bandwidth class in FBG2 to indicate the maximum number of 200 MHz component carriers supported. For example, for the user equipment 10 that supports carrier aggregation bandwidth class R12 with a maximum aggregated bandwidth capability of 1600 MHz, the user equipment 10 may, in addition to signaling support of the carrier aggregation bandwidth class R12, also signal support of the carrier aggregation bandwidth class U in FBG2. This may indicate to the base station 104 and/or the network 102 that, out of the 12 supported component carriers for the carrier aggregation bandwidth class R12, the user equipment 10 may support at least eight individual component carriers of 200 MHz. As a result, the network 102 may determine that the user equipment 10 may support the following configurations as the highest envelope (e.g., maximum bandwidth) in each CA BW class:
R12: 8×100 MHz+4×200 MHz, where the network 102 allocates the aggregated component carriers having an aggregated bandwidth equal to the maximum aggregated bandwidth capability;
R11: 6×100 MHz+5×200 MHz, where the network 102 allocates the aggregated component carriers having an aggregated bandwidth equal to the maximum aggregated bandwidth capability;
R10: 4×100 MHz+6×200 MHz, where the network 102 allocates the aggregated component carriers having an aggregated bandwidth equal to the maximum aggregated bandwidth capability;
R9: 2×100 MHz+7×200 MHz, where the network 102 allocates the aggregated component carriers having an aggregated bandwidth equal to the maximum aggregated bandwidth capability;
R8: 8×200 MHz, where the network 102 allocates the aggregated component carriers having an aggregated bandwidth equal to the maximum aggregated bandwidth capability and/or the maximum bandwidth for the carrier bandwidth classes R8 and U;
R7: 7×200 MHz, where the network 102 allocates the aggregated component carriers having an aggregated bandwidth equal to the maximum bandwidth for the carrier bandwidth classes R7 and T;
R6: 6×200 MHz, where the network 102 allocates the aggregated component carriers having an aggregated bandwidth equal to the maximum bandwidth for the carrier bandwidth classes R6 and S;
R5: 5×200 MHz, where the network 102 allocates the aggregated component carriers having an aggregated bandwidth equal to the maximum bandwidth for the carrier bandwidth classes R5 and R;
R4: 4×200 MHz, where the network 102 allocates the aggregated component carriers having an aggregated bandwidth equal to the maximum bandwidth for the carrier bandwidth classes R4 and F;
R3: 3×200 MHz, where the network 102 allocates the aggregated component carriers having an aggregated bandwidth equal to the maximum bandwidth for the carrier bandwidth classes R3 and E;
R2: 2×200 MHz, where the network 102 allocates the aggregated component carriers having an aggregated bandwidth equal to the maximum bandwidth for the carrier bandwidth classes R2 and D.

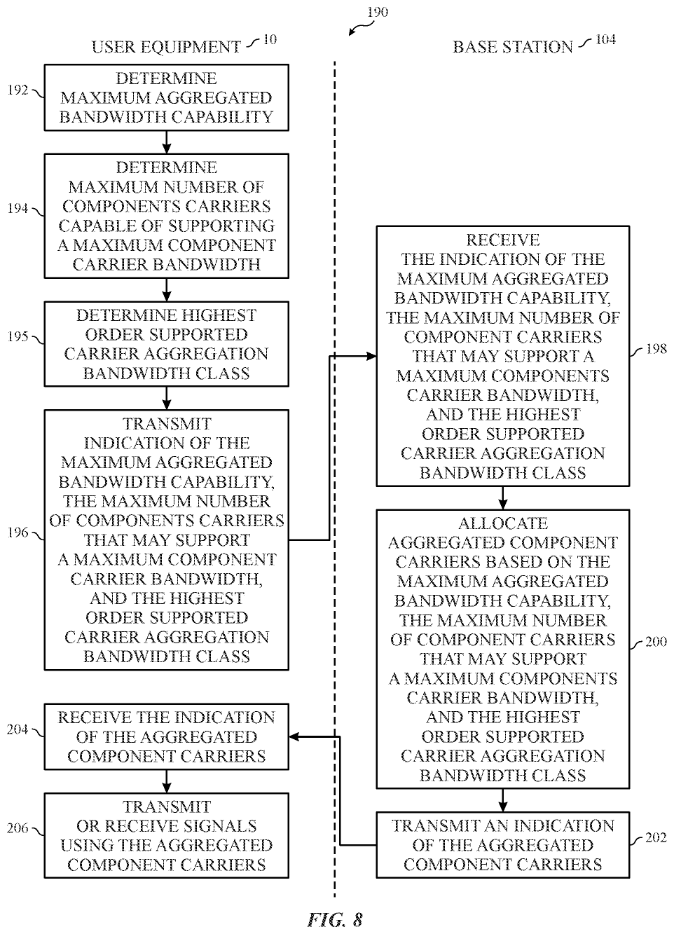

FIG. 8 is a flowchart of a method 190 for performing carrier aggregation by indicating a maximum aggregated bandwidth capability and a maximum number of components carriers capable of supporting a maximum components carrier bandwidth, according to embodiments of the present disclosure. Any suitable device (e.g., a controller) that may control components of the user equipment 10, the base station 104, and/or the network 102, such as the processor 12, may perform the method 190. In some embodiments, the method 190 may be implemented by executing instructions stored in a tangible, non-transitory, computer-readable medium, such as the memory 14 or storage 16, using the processor 12. For example, the method 190 may be performed at least in part by one or more software components, such as an operating system of the user equipment 10, the base station 104, and/or the network 102, one or more software applications of the user equipment 10, the base station 104, and/or the network 102, and the like. While the method 190 is described using steps in a specific sequence, it should be understood that the present disclosure contemplates that the described steps may be performed in different sequences than the sequence illustrated, and certain described steps may be skipped or not performed altogether.

In process block 192, the user equipment 10 determines a maximum aggregated bandwidth capability. In process block 194, the user equipment 10 determines a maximum number of components carriers capable of supporting a maximum component carrier bandwidth. In process block 195, the user equipment 10 determines a highest order supported carrier aggregation bandwidth class. In particular, the user equipment 10 may determine a maximum number of component carriers it supports, and determine the highest order supported carrier aggregation bandwidth class based on the maximum number of component carriers. For example, the user equipment 10 may determine the highest order supported carrier aggregation bandwidth class on the table 130 of FIGS. 5A and 5B that corresponds to the maximum number of supported component carriers.

In process block 196, the user equipment 10 transmits an indication of the maximum aggregated bandwidth capability, the maximum bandwidth capability for each component carrier to the base station 104, and the highest order supported carrier aggregation bandwidth class. In particular, the maximum aggregated bandwidth capability may be indicated as a single value or in a single field, and be independent from the user equipment's 10 per component carrier bandwidth capability.

In process block 198, the base station 104 receives the indication of the maximum aggregated bandwidth capability, the maximum number of components carriers capable of supporting the maximum component carrier bandwidth, and the highest order supported carrier aggregation bandwidth class. In process block 200, the base station 104 and/or the network 102 allocates aggregated component carriers based on the maximum aggregated bandwidth capability, the maximum number of components carriers capable of supporting the maximum component carrier bandwidth, and the highest order supported carrier aggregation bandwidth class, as described in the example above. In process block 202, the base station 104 transmits an indication of the aggregated component carriers to the user equipment 10.

In process block 204, the user equipment 10 receives the indication of the aggregated component carriers. In process block 206, the user equipment 10 transmits and/or receives signals (e.g., uplinks or downlinks user data) using the aggregated component carriers. In this manner, the method 190 performs carrier aggregation by indicating a maximum aggregated bandwidth capability and a maximum number of components carriers capable of supporting a maximum components carrier bandwidth.

While the disclosed embodiments include indicating the maximum aggregated bandwidth capability as a new information element (IE), maxaggregatedBW, in additional or alternative embodiments, the user equipment 10 may indicate the maximum aggregated bandwidth capability using existing signaling provided by the 3GPP standard, such as by indicating the maximum aggregated bandwidth capability using a frequency separation class signal. For example, the frequency separation class signal may include information elements intraBandFreqSeparationDL, intraBandFreqSeparationDL-v1620, intraBandFreqSeparationUL, intraBandFreqSeparationUL-v1620, as defined for intra-band noncontiguous carrier aggregation. For example, in the methods 150 of FIG. 6, 170 of FIG. 7, and/or 190 of FIG. 8, the user equipment 10 may indicate the maximum aggregated bandwidth capability using the frequency separation class signal.

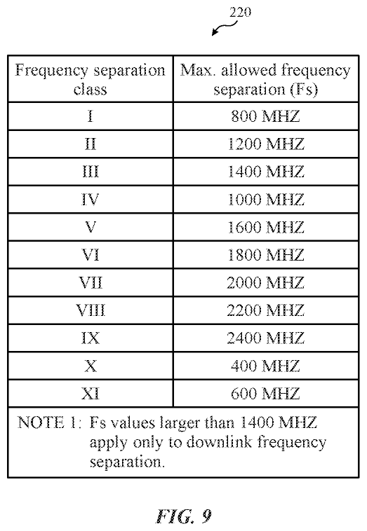

It should be understood that the frequency separation classes may be specified for (e.g., only specified for) intra-band noncontiguous carrier aggregation. FIG. 9 is a table 220 of frequency separation classes for noncontiguous intra-band operation. The distinction between contiguous carrier aggregation and noncontiguous carrier aggregation is that when adjacent carrier spacing is larger than a nominal channel spacing, it is defined as noncontiguous carrier aggregation; otherwise, it is contiguous carrier aggregation. When the intra-band noncontiguous carrier aggregation adjacent carrier spacing is slightly above the nominal channel spacing, its radio frequency characteristics may be similar to or the same as contiguous carrier aggregation. Therefore, the frequency separation classes may also be applied to contiguous carrier aggregation.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. User equipment comprising:
a transmitter configured to transmit a first indication of a maximum aggregated bandwidth capability to a base station;
a receiver configured to receive a second indication of aggregated component carriers based on the maximum aggregated bandwidth capability from the base station; and
processing circuitry configured to transmit, via the transmitter, or receive, via the receiver, signals using the aggregated component carriers.

2. The user equipment of claim 1, wherein the first indication comprises a field corresponding to the maximum aggregated bandwidth capability.

3. The user equipment of claim 1, wherein the first indication comprises a field corresponding a frequency separation class.

4. The user equipment of claim 1, wherein the transmitter is configured to transmit a third indication of a maximum bandwidth capability for each component carrier to the base station.

5. The user equipment of claim 4, wherein the receiver is configured to receive the second indication of aggregated component carriers based on the maximum aggregated bandwidth capability and the maximum bandwidth capability for each component carrier from the base station.

6. The user equipment of claim 1, wherein the transmitter is configured to transmit a third indication of maximum number of components carriers capable of supporting a maximum component carrier bandwidth to the base station.

7. The user equipment of claim 6, wherein the receiver is configured to receive the second indication of aggregated component carriers based on the maximum aggregated bandwidth capability and the maximum number of components carriers capable of supporting the maximum component carrier bandwidth from the base station.

8. The user equipment of claim 6, wherein maximum component carrier bandwidth comprises 200 megahertz.

9. One or more non-transitory, tangible, computer-readable media storing instructions that, when executed, cause one or more processors to:
receive a first indication of a maximum aggregated bandwidth capability from user equipment;
allocate aggregated component carriers based on the maximum aggregated bandwidth capability to the user equipment; and
transmit a second indication of the aggregated component carriers to the user equipment.

10. The one more non-transitory, tangible, computer-readable media of claim 9, wherein the instructions cause the one or more processors to receive a third indication of a carrier aggregation bandwidth class from the user equipment.

11. The one more non-transitory, tangible, computer-readable media of claim 10, wherein the instructions cause the one or more processors to allocate the aggregated component carriers based on the maximum aggregated bandwidth capability and according to the carrier aggregation bandwidth class to the user equipment.

12. The one more non-transitory, tangible, computer-readable media of claim 10, wherein the instructions cause the one or more processors to allocate the aggregated component carriers based on the maximum aggregated bandwidth capability and according to a lower order carrier aggregation bandwidth class than the carrier aggregation bandwidth class to the user equipment.

13. The one more non-transitory, tangible, computer-readable media of claim 12, wherein the lower order carrier aggregation bandwidth class comprises a maximum bandwidth greater than the maximum aggregated bandwidth capability, and an aggregated bandwidth of the aggregated component carriers comprises the maximum aggregated bandwidth capability.

14. The one more non-transitory, tangible, computer-readable media of claim 12, wherein the instructions cause the one or more processors to receive a third indication of a component carrier configuration from the user equipment.

15. The one more non-transitory, tangible, computer-readable media of claim 14, wherein the lower order carrier aggregation bandwidth class comprises a maximum bandwidth less than the maximum aggregated bandwidth capability, and the instructions cause the one or more processors to determine a maximum bandwidth of each component carrier based on the component carrier configuration.

16. A method comprising:
transmitting, via a transmitter of user equipment, a first indication of a maximum aggregated bandwidth capability to a base station;
receiving, via a receiver of the user equipment, a second indication of aggregated component carriers based on the maximum aggregated bandwidth capability from the base station; and
transmitting, via the transmitter, or receiving, via the receiver, signals using the aggregated component carriers.

17. The method of claim 16, comprising transmitting, via the transmitter, a third indication of a maximum bandwidth capability for each component carrier to the base station.

18. The method of claim 17, wherein the second indication of aggregated component carriers is based on the maximum aggregated bandwidth capability and the maximum bandwidth capability for each component carrier from the base station.

19. The method of claim 16, comprising transmitting, via the transmitter, a third indication of a maximum number of components carriers capable of supporting a maximum component carrier bandwidth to the base station.

20. The method of claim 19, wherein the second indication of aggregated component carriers is based on the maximum aggregated bandwidth capability and the maximum number of components carriers capable of supporting the maximum component carrier bandwidth from the base station.
